(19) United States
(12) Patent Application Publication
(10) Pub. No.: US 2020/0013137 A1
(43) Pub. Date: Jan. 9, 2020

(54) FIXED-STRIDE DRAW TABLES FOR TILED RENDERING

(71) Applicant: QUALCOMM Incorporated, San Diego, CA (US)

(72) Inventors: Richard Hammerstone, Tyngsboro, MA (US); Nigel Poole, West Newton, MA (US); Thomas Edwin Frisinger, Shrewsbury, MA (US); Andrew Evan Gruber, Arlington, MA (US); Anisha Datla, Watertown, MA (US)

(21) Appl. No.: 16/028,151

(22) Filed: Jul. 5, 2018

(51) Int. Cl. G06T 1/20; G06T 15/00; G06T 11/20

(52) U.S. Cl. CPC G06T 1/20; G06T 11/20; G06T 15/005

(57) ABSTRACT

Methods, systems, and devices for rendering are described. A device may divide a frame into a plurality of bins. The device may generate a command stream containing multiple repetitions of a fixed-stride draw table (FSDT), where each repetition of the FSDT includes a respective state vector for one or more hardware registers of a set of hardware registers. The device may identify, for each bin, a subset of the multiple repetitions of the FSDT in the command stream that include a live draw call. The device may execute, using the set of hardware registers, one or more rendering commands for each bin based at least in part on the corresponding subset of the multiple repetitions of the FSDT.

### BACKGROUND

The following relates generally to rendering, and more specifically to fixed-stride draw tables for tiled rendering.

A device that provides content for visual presentation on an electronic display generally includes a graphics processing unit (GPU). The GPU (in conjunction with other components) renders pixels that are representative of the content on the display. That is, the GPU generates values for each pixel on the display and performs graphics processing on the pixel values to render each pixel for presentation. For example, the GPU may convert two-dimensional or three-dimensional virtual objects into a two-dimensional pixel representation that may be displayed. Converting information about three-dimensional objects into a bitmap that can be displayed in two dimensions is known as pixel rendering and requires considerable memory and processing power. Three-dimensional graphics accelerators that support pixel rendering operations are becoming increasingly available in devices such as personal computers, smartphones, tablet computers, gaming devices, etc. Such devices may in some cases have constraints on computational power, memory capacity, and/or other processing parameters. Accordingly, three-dimensional graphics rendering may present difficulties when being implemented on these devices. Improved rendering techniques may be desired.

### SUMMARY

The described techniques relate to improved methods, systems, devices, and apparatuses that support fixed-stride draw tables (FSDTs) for tiled rendering. Generally, the described techniques provide for improved identification and processing of live draw calls in a command stream. As an example, a command processor of a graphics processing unit (GPU) may identify indices for each live draw call associated with a given tile (or bin) and identify a location of the draw call within the command buffer based on a stride length associated with the FSDT. That is, if the size of the state vector is constant for each draw call (e.g., if each repetition of the FSDT has a same size), the command processor can skip directly to the live draw calls for each bin by multiplying the stride length (e.g., the size of each repetition of the FSDT) by the index of the draw call. With this information, the command processor may implement a direct memory access (DMA) engine that uses a visibility stream to fetch only the live draw calls and their associated states for a given bin (e.g., while dead draws and the associated states may be skipped) for tiled rendering applications. These techniques may improve rendering quality (e.g., by reducing latency), may reduce processing costs (e.g., by allowing a central processor to skip writing dummy state values for dead draw calls), or may provide other such benefits to a rendering device.

A method of rendering at a device is described. The method may include dividing a frame into a set of bins, generating a command stream including a set of repetitions of a FSDT, where each repetition of the FSDT includes a respective state vector for one or more hardware registers of a set of hardware registers, identifying, for each bin, a subset of the set of repetitions of the FSDT in the command stream that include a live draw call, and executing, using the set of hardware registers, one or more rendering commands for each bin based on the corresponding subset of the set of repetitions of the FSDT.

An apparatus for rendering is described. The apparatus may include a processor, memory in electronic communication with the processor, and instructions stored in the memory. The instructions may be executable by the processor to cause the apparatus to divide a frame into a set of bins, generate a command stream including a set of repetitions of a FSDT, where each repetition of the FSDT includes a respective state vector for one or more hardware registers of a set of hardware registers, identify, for each bin, a subset of the set of repetitions of the FSDT in the command stream that include a live draw call, and execute, using the set of hardware registers, one or more rendering commands for each bin based on the corresponding subset of the set of repetitions of the FSDT.

Another apparatus for rendering is described. The apparatus may include means for dividing a frame into a set of bins, generating a command stream including a set of repetitions of a FSDT, where each repetition of the FSDT includes a respective state vector for one or more hardware registers of a set of hardware registers, identifying, for each bin, a subset of the set of repetitions of the FSDT in the command stream that include a live draw call, and executing, using the set of hardware registers, one or more rendering commands for each bin based on the corresponding subset of the set of repetitions of the FSDT.

A non-transitory computer-readable medium storing code for rendering at a device is described. The code may include instructions executable by a processor to divide a frame into a set of bins, generate a command stream including a set of repetitions of a FSDT, where each repetition of the FSDT includes a respective state vector for one or more hardware registers of a set of hardware registers, identify, for each bin, a subset of the set of repetitions of the FSDT in the command stream that include a live draw call, and execute, using the set of hardware registers, one or more rendering commands for each bin based on the corresponding subset of the set of repetitions of the FSDT.

In some examples of the method, apparatuses, and non-transitory computer-readable medium described herein, generating the command stream may include operations, features, means, or instructions for generating a set of one or more repetition indices for each bin, where each repetition index indicates a respective repetition of the FSDT that includes a live draw call for that bin.

In some examples of the method, apparatuses, and non-transitory computer-readable medium described herein, executing the one or more rendering commands for each bin may include operations, features, means, or instructions for localizing a DMA engine of a GPU to the subset of the set of repetitions of the FSDT that include a live draw call for that bin within the command stream based on the corresponding set of one or more repetition indices.

Some examples of the method, apparatuses, and non-transitory computer-readable medium described herein may further include operations, features, means, or instructions for computing a stride length between successive repetitions of the FSDT that include a live draw call for that bin based on a size of the FSDT and the repetition indices for the successive repetitions of the FSDT, where the DMA engine may be localized based on the stride length.

In some examples of the method, apparatuses, and non-transitory computer-readable medium described herein, each repetition of the FSDT includes a respective state vector for each hardware register of the set of hardware registers.

In some examples of the method, apparatuses, and non-transitory computer-readable medium described herein, each repetition of the FSDT includes a respective state vector for each hardware register of the set of hardware registers.

Some examples of the method, apparatuses, and non-transitory computer-readable medium described herein may further include operations, features, means, or instructions for performing a visibility pass operation on the set of bins, where the subset of the set of repetitions of the FSDT in the command stream that include a live draw call for each bin may be identified based on the visibility pass operation.

Some examples of the method, apparatuses, and non-transitory computer-readable medium described herein may further include operations, features, means, or instructions for passing the command stream from a central processor of the device to a command processor of a GPU.

### BRIEF DESCRIPTION OF THE DRAWINGS

FIG. 1 illustrates an example of a binning layout that supports fixed-stride draw tables for tiled rendering in accordance with aspects of the present disclosure.

FIG. 2 illustrates an example of a command stream that supports fixed-stride draw tables for tiled rendering in accordance with aspects of the present disclosure.

FIG. 3 illustrates an example of an initial draw state that supports fixed-stride draw tables for tiled rendering in accordance with aspects of the present disclosure.

FIGS. 4A and 4B illustrate example fixed-stride draw entries that support fixed- stride draw tables for tiled rendering in accordance with aspects of the present disclosure.

FIG. 5 illustrates an example of a packet that supports fixed-stride draw tables for tiled rendering in accordance with aspects of the present disclosure.

FIG. 6 shows a block diagram of a device that supports fixed-stride draw tables for tiled rendering in accordance with aspects of the present disclosure.

FIG. 7 shows a diagram of a system including a device that supports fixed-stride draw tables for tiled rendering in accordance with aspects of the present disclosure.

FIGS. 8 through 10 show flowcharts illustrating methods that support fixed-stride draw tables for tiled rendering in accordance with aspects of the present disclosure.

### DETAILED DESCRIPTION

Some graphics processing unit (GPU) architectures may require a relatively large amount of data to be read from and written to system memory when rendering a frame of graphics data (e.g., an image). Mobile architectures (e.g., GPUs on mobile devices) may lack the memory bandwidth capacity required for processing entire frames of data. Accordingly, bin-based architectures may be utilized to divide an image into multiple bins (e.g., tiles). The bins may be sized so that they can be processed using a relatively small amount of high bandwidth, on-chip graphics memory.

Aspects of the present disclosure relate to efficiently identifying live draw commands in a command stream. For example, a device may perform a visibility pass operation (e.g., which may work on a plurality of bins comprising a given image in parallel) and generate visibility information for each bin (e.g., a list of visible primitives, indices to a list of primitives, or the like). The visibility pass operation may indicate which draw commands are visible in each bin as well as which primitives are visible within each draw command. Aspects of the present disclosure relate to techniques for quickly identifying and processing portions of a command buffer (e.g., which may alternatively be referred to as a command stream) to identify visible draw commands for a given bin (e.g., rather than submitting and processing the full command buffer once for every bin).

Aspects of the disclosure are initially described in the context of a binning layout. Aspects of the disclosure are then illustrated by and described with reference to command streams, example draw table entries, and example packets (e.g., indirect buffer packets, draw table packets, etc.). Aspects of the disclosure are further illustrated by and described with reference to apparatus diagrams, system diagrams, and flowcharts that relate to fixed-stride draw tables for tiled rendering.

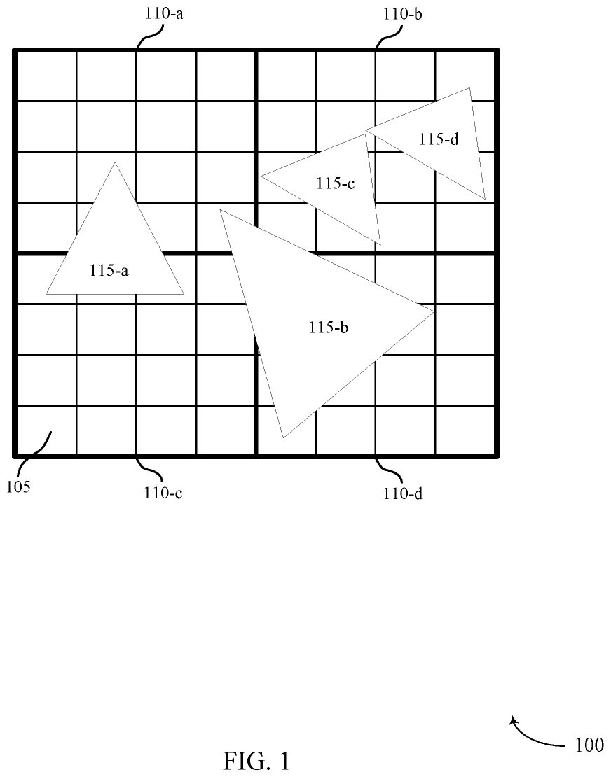

FIG. 1 illustrates an example of a binning layout 100 that supports fixed-stride draw tables for tiled rendering in accordance with aspects of the present disclosure. Binning layout 100 may illustrate a two-dimensional representation of a three-dimensional scene, where the two-dimensional representation may be displayed as a plurality of pixels 105. The two-dimensional representation may be generated based at least in part on primitives 115 (e.g., which are illustrated as triangles for the sake of explanation but may be other geometric shapes without deviating from the scope of the present disclosure). The plurality of pixels 105 comprising binning layout 100 may be divided into bins 110. Each bin 110 may have a same size and/or shape. Alternatively, the sizes and/or shapes of the bins 110 may vary.

Bin rendering may in some cases be described with respect to a number of processing passes. For example, when performing bin-based rendering, a central processing unit (CPU) or GPU may perform a visibility pass and one or more rendering passes. With respect to the visibility pass, the CPU (or GPU) may process an entire image and sort rasterized primitives 115 into bins 110. A visibility stream may be used to indicate the primitives 115 that are visible in the final image and the primitives 115 that are invisible in the final image. For example, a primitive 115 may be invisible if it is obscured by one or more other primitives 115 such that the primitive 115 cannot be seen in the final reconstructed image. A visibility stream may be generated for an entire image, or may be generated on a per-bin basis (e.g., one visibility stream for each bin 110). Generally, a visibility stream may include a series of bits, with each “1” or “0” being associated with a particular primitive 115. Each “1” may, for example, indicate that the primitive 115 is visible in the final image, while each “0” may indicate that the primitive 115 is invisible in the final image. In some cases, the visibility stream may control the rendering pass(es). For example, the visibility stream may be used to forego the rendering of invisible primitives 115. Accordingly, only the primitives that actually contribute to a bin 110 (e.g., that are visible in the final image) may be rendered and shaded, thereby reducing a number of rendering and shading operations performed by the GPU (e.g., resulting in power savings, improved throughput, or other such benefits).

In other examples, the CPU or GPU may use a different process (e.g., other than or in addition to the visibility streams described above) to classify primitives 115 as being located in (e.g., and visible in) a particular bin 110. For example, a GPU may output a separate list per bin 110 of “indices” that represent only the primitives 115 that are present in a given bin 110. For example, the GPU may initially include all the primitives 115 (e.g., vertices defining the primitives 115) in one data structure. The GPU may generate a set of pointers into the data structure for each bin 110 that only points to the primitives 115 that are visible in each bin 110. Such pointers may serve a similar purpose as the visibility streams described above, with the pointers indicating which primitives 115 are visible in a particular bin 110 (e.g., and which pixels 105 are associated with those primitives 115).

Each bin 110 may be rendered/rasterized (e.g., by a GPU) to contain multiple pixels 105, which pixels 105 may be shown via a display. One or more primitives 115 may be visible in each bin 110. For example, portions of primitive 115-a are visible in both bin 110-a and bin 110-c. Portions of primitive 115-b are visible in bin 110-a, bin 110-b, bin 110-c, and bin 110-d. Primitive 115-c and primitive 115-d are only visible in bin 110-b. Binning layout 100 may include other primitives 115, at least some of which may not be visible in the final rendering target. During a rendering pass for a given bin 110, all visible primitives 115 in that bin 110 may be rendered. For example, a visibility pass may be performed for each bin 110 (e.g., or for the frame as a whole during a visibility pass) to determine load estimation information and/or to determine which primitives 115 are visible in the final rendered scene. The visibility pass may be performed by a GPU or by specialized hardware (e.g., a hardware accelerator), which may be referred to as a visibility stream processor. For example, some primitives 115 may be behind one or more other primitives 115 (e.g., may be occluded), and such occluded primitives 115 may not need to be rendered for a given bin 110.

For a given rendering pass, the pixel data for the bin 110 associated with that particular rendering pass may be stored in a GPU memory. After performing the rendering pass, the GPU may transfer the contents of the GPU memory to a display buffer. In some cases, the GPU may overwrite a portion of the data in the display buffer with the rendered data stored in the GPU memory. After transferring the contents of GPU memory to the display buffer, the GPU may initialize the GPU memory to default values and begin a subsequent rendering pass with respect to a different bin 110.

In accordance with aspects of the present disclosure, a device may utilize a command stream that includes one or more repetitions of a fixed-stride draw table (FSDT) in support of binning layout 100. For example, the FSDT may be used to create a full set of state vectors for each draw call, making each draw call independent from the other draw calls in the command stream (e.g., and thereby removing the incremental nature of state updates). Such draw call independence may reduce processing overhead, reduce rendering latency, or otherwise benefit a device (e.g., a mobile device) by eliminating dead draw calls (and their associated state vectors) from a processing queue for each bin 110.

Aspects of the present disclosure relate to using data packets to specify state vectors for graphics hardware (e.g., which may compress the amount of data that needs to go into a command stream down to five, ten, one-hundred, etc. pointers and sizes). If the size of the state vector is constant for each draw call (e.g., as described with reference to the fixed-stride draw repetition examples provided below), a command processor of a GPU may implicitly know where each live draw call for a given bin 110 is in the command stream and may skip directly to them by simply multiplying the size or stride of each draw (e.g., and state vector) by the index of the draw. With this information, the command processor may implement a specialized direct memory access (DMA) engine that uses the visibility stream to fetch only the live draw calls (and their associated states), while the dead draw calls (and their associated states) may be skipped completely. Thus, rather than submitting a command stream once per bin 110, a CPU may provide a single command stream to the command processor of the GPU, which may identify live draw calls within the command stream on a per-bin basis (e.g., based on bin-specific information provided along with the command stream such as repetition indices, as discussed herein).

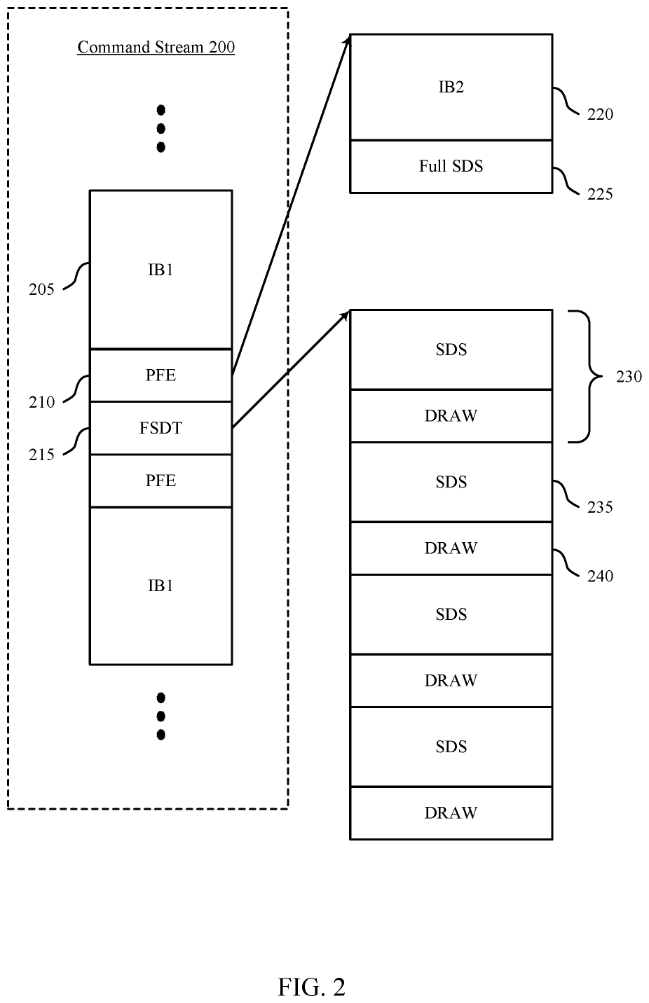

FIG. 2 illustrates an example of a command stream 200 that supports fixed-stride draw tables for tiled rendering in accordance with aspects of the present disclosure. Command stream 200 may, for example, be passed from a CPU of a device to a GPU and may control rendering operations performed by the GPU. Command stream 200 may include one or more levels of indirection (e.g., indirect buffer 1 (IB1) 205, IB packet forwarding engines (PFEs) 210) and FSDT entries 215.

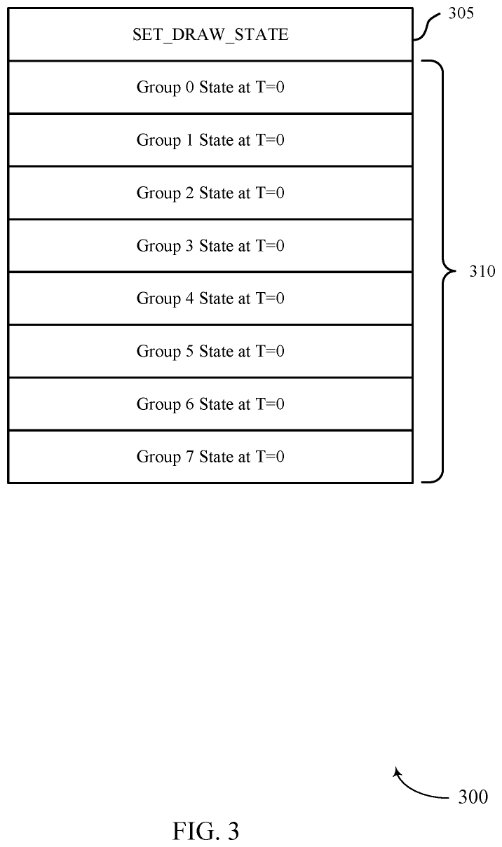

For example, IB1 205 may contain information related to register states, shading operations, texturing operations, visibility pass information (e.g., the visibility streams discussed herein), or other such information. PFE 210 may index IB2 command packets (e.g., which may contain IB2 information 220 and a SET_DRAW_STATE (SDS) vector 225). IB2 information 220 may include various information (e.g., may clear registers to black for a given bin) while SDS vector 225 may be an example of the initial draw state 300 described with reference to FIG. 3.

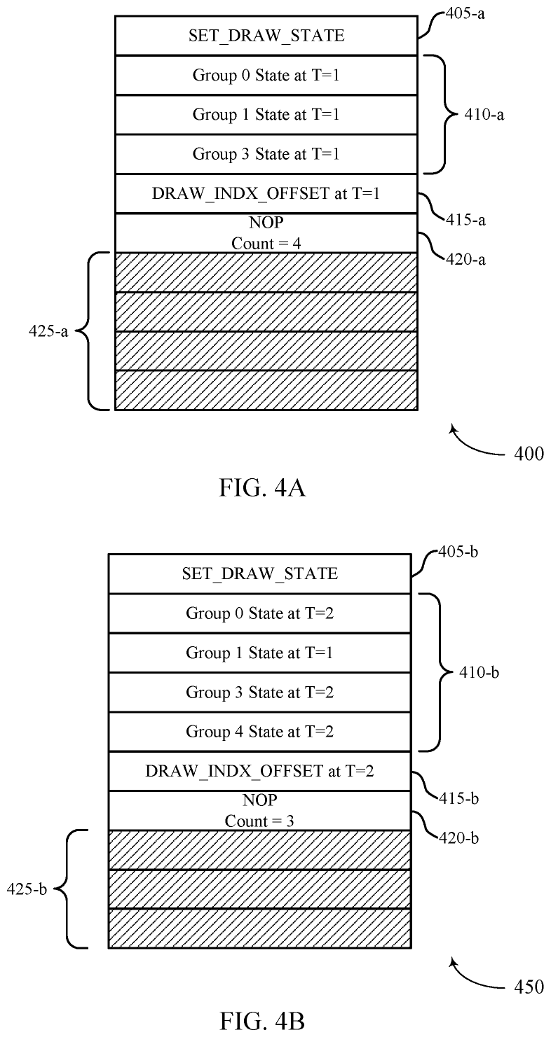

Each FSDT entry 215 may include a plurality of FSDT repetitions 230, where each FSDT repetition 230 may be an example of the fixed-stride draw entries discussed with reference to FIGS. 4A and 4B. For example, each FSDT repetition 230 may include SDS information 235 and draw command 240. Each FSDT repetition 230 may be associated with one or more (e.g., or all) bins for a given frame. In accordance with aspects of the present disclosure, a command processor of a GPU may identify live draw commands 240 within FSDT entry 215 that are associated with a given bin and may only process SDS information 235 for the live draw commands 240. Because the draw commands 240 (e.g., and associated SDS information 235) may be independent from one another (e.g., as provided for by aspects of the present disclosure), the GPU may skip FSDT repetitions 230 within FSDT entry 215 without having to incrementally update state vectors of hardware registers.

FIG. 3 illustrates an example of an initial draw state 300 that supports fixed-stride draw tables for tiled rendering in accordance with aspects of the present disclosure. For example, initial draw state 300 may be an example of SDS vector 225 as described with reference to FIG. 2. Initial draw state 300 may, for example, be included in an IB2 of a command stream prior to an FSDT entry. Initial draw state 300 may support aspects of the present disclosure related to draw command-independence (e.g., by allowing SDS information 235 of a given FSDT repetition to indicate a delta state vector from initial draw state 300 rather than having each SDS information 235 depend at least in part on SDS information earlier in the FSDT entry).

Initial draw state 300 may include SDS identifier 305 and a full set of SDS pointers 310. For example, each SDS pointer may be associated with a given state group (e.g., a given group of hardware registers). While eight SDS pointers are included in the present example, it is to be understood that any suitable number of SDS pointers (e.g., 12, 64, 100, etc.) may be used without deviating from the scope of the present disclosure. The FSDT stride length may depend on the number of SDS pointers. Aspects of the present disclosure relate to various fixed-stride draw entries that may be used in conjunction with initial draw state 300. For example, a delta vector may be used (e.g., as described with reference to FIGS. 4A and 4B) in which the GPU driver does not have to send a full set of state pointers for each draw call, but may instead send a set of deltas from the initial draw state 300. For example, the set of deltas may include any state which is new for the current draw call along with any state that had changed prior to the current draw call. Because the delta vector may vary for different draw calls, enough space may be allocated within a command stream for a full set of states for each FSDT repetition (e.g., but a No Operation (NOP) packet may be used to fill any unused space for a given draw call). Alternatively, dummy state pointers may be used for states that do not change from the value set by initial draw state 300. The use of a NOP packet may in some cases require the driver to write a single NOP header value (e.g., rather than multiple dummy state pointers for each draw call), which may result in power saving or other processing benefits for the driver.

Using the delta state mechanism in support of FSDT operations may reduce the overhead needed for software to send a full set of SDS pointers 310 per draw command, but may also introduce complications if preemption happens while processing a FSDT. That is, if preemption occurs, the device may need to consider the possibility that the initial draw state 300 (to which the delta vectors are being applied) has been lost. YIELD level preemption and bin-level preemption may be successfully handled by the described techniques (e.g., as FSDT entries may not be split across D31 lists or bin boundaries). The described techniques may handle draw call or primitive-level preemption if the three-dimensional register state is saved and restored. If the state is not saved and restored, the device may create a preamble that contains the fully-populated SDS command that was used to establish the initial state before the FSDT was initiated. Once the preamble is sent to the hardware, the command processor may resume processing the FSDT at the beginning of the entry where it was interrupted.

FIG. 4A illustrates an example of a fixed-stride draw repetition 400 that supports fixed-stride draw tables for tiled rendering in accordance with aspects of the present disclosure. For example, fixed-stride draw repetition 400 may be an example of a FSDT repetition 230 described with reference to FIG. 2. Fixed-stride draw repetition 400 may be included in IB1 along with other IB2 control packets, such as PM4 command packets as defined and standardized by Advanced Micro Devices, for a command stream. Fixed-stride draw repetition 400 may not be able to be supported in an IB2 (e.g., because there is no free extra level of indirection) or a ring buffer.

Fixed-stride draw repetition 400 may in some cases represent a delta vector from an initial draw state (e.g., initial draw state 300 described with reference to FIG. 3). Each fixed-stride draw repetition 400 may therefore contain a set of state deltas from these initial values (e.g., group states 410-a) along with draw command 415-a. Additionally, fixed-stride draw repetition 400 may include SDS 405-a and NOP 420-a (e.g., a NOP header). For example, fixed-stride draw repetition 400 may be used to change state group 0, state group 1, and state group 3, and may contain NOP 420-a (e.g., to indicate unused space 425-a in the fixed-stride draw repetition 400). For example, fixed-stride draw repetition 400 may have a stride length of ten units (e.g., though other stride lengths may be used). Because only three state groups are needed to describe the delta from the initial state, there may be four unused units in unused space 425-a. By allowing the GPU driver to skip writing state vectors that are redundant with the initial state vector, device operation may be improved.

FIG. 4B illustrates an example of a fixed-stride draw repetition 450 that supports fixed-stride draw tables for tiled rendering in accordance with aspects of the present disclosure. For example, fixed-stride draw repetition 450 may be an example of a FSDT repetition 230 described with reference to FIG. 2. Fixed-stride draw repetition 450 may be included in IB1 along with other IB2 control (e.g., PM4) packets for a command stream. Fixed-stride draw repetition 450 may not be able to be supported in an IB2 (e.g., because there is no free extra level of indirection) or a ring buffer.

Fixed-stride draw repetition 450 may follow fixed-stride draw repetition 400 in a command stream (e.g., in a given FSDT entry as described with reference to FIG. 2). Fixed-stride draw repetition 450 may in some cases represent a delta vector from an initial draw state in consideration of fixed-stride draw repetition 400. Fixed-stride draw repetition 450 may therefore contain a set of state deltas from these initial values (e.g., group states 410-b) along with draw command 415-b. Additionally, fixed-stride draw repetition 450 may include SDS 405-b and NOP 420-b (e.g., a NOP header). For example, fixed-stride draw repetition 450 may be used to change state group0, state group 3, and state group 4, and may contain NOP 420-b (e.g., to indicate unused space 425-b in the fixed-stride draw repetition 450). For example, fixed-stride draw repetition 450 may have a stride length of ten units (e.g., though other stride lengths may be used). Because only four state groups are needed to describe the delta from the initial state (e.g., three new state groups for the current draw call and one old state group from the previous draw call), there may be three unused units in unused space 425-b. By allowing the GPU driver to skip writing state vectors that are redundant with the initial state vector, device operation may be improved. Using the delta state vectors may allow the set of SDS pointers (e.g., group states 410) to grow across sequential FSDT repetitions (e.g., which may remove the need to scan the application programming interface (API) input stream or to use post-processing to generate a minimal set of SDS groups).

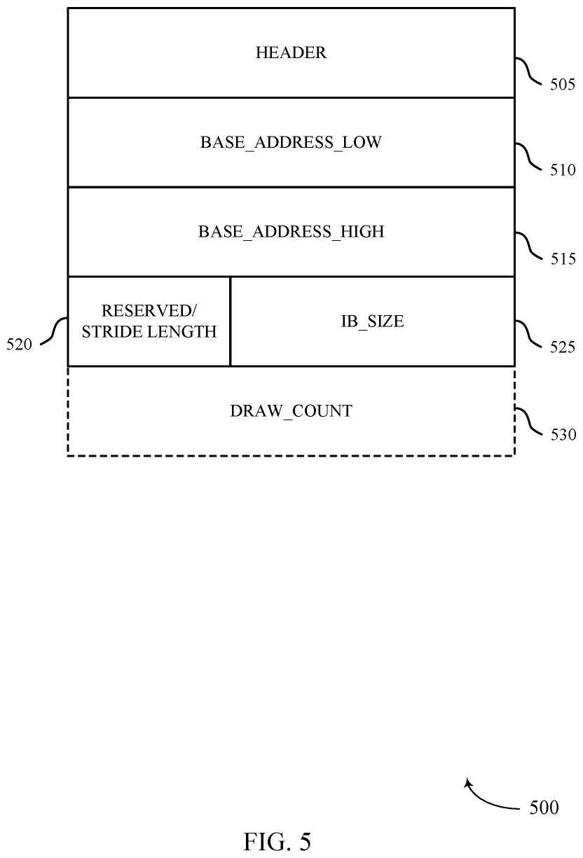

FIG. 5 illustrates an example of a packet 500 that supports fixed-stride draw tables for tiled rendering in accordance with aspects of the present disclosure. For example, packet 500 may represent an D3 PM4 packet or a FSDT PM4 packet. FSDT buffers may work with any register state of PM4 commands that are normally placed in an IB2. Like an SDS group, the register state may be written for every draw call (e.g., or may be written before the FSDT to establish an initial state) and then (once modified) may be written for each subsequent draw call. Thus, space may be reserved in the FSDT buffer to make the stride consistent for each draw call.

To improve processing efficiency, a command processor may treat an FSDT buffer as a specialized form of IB2 (e.g., which may improve the ability of the command processor to pre-fetch live draws in the FSDT). The FSDT buffer (e.g., which may be used to refer to packet 500 for FSDT-specific uses) may contain only FSDT entries. The layout of the FSDT PM4 packet used to specify an FSDT buffer may be the same as an D3 PM4 packet. Packet 500 may include header 505, low base address 510, high base address 515, stride length field 520, D3 size 525, and draw count field 530. Stride length field 520 (e.g., the fourth word of the packet) may represent a reserved field for the IB PM4 packet but may indicate the stride length for the FSDT. Stride length field 520 may support strides of up to 4096 words. Draw count field 530 may be optional for IB PM4 packets but may be required for FSDT packets. In terms of buffer allocation and management, the handling of an FSDT buffer may be the same as an IB2 buffer. The two buffers (e.g., packet formats) may differ in terms of contents and the fact that the FSDT buffer has an associated stride length. If the FSDT buffer grows larger than the allocated memory, it may be split across multiple buffers (e.g., as long as the software allocates a new buffer and inserts a new FSDT PM4 packet in the D31).

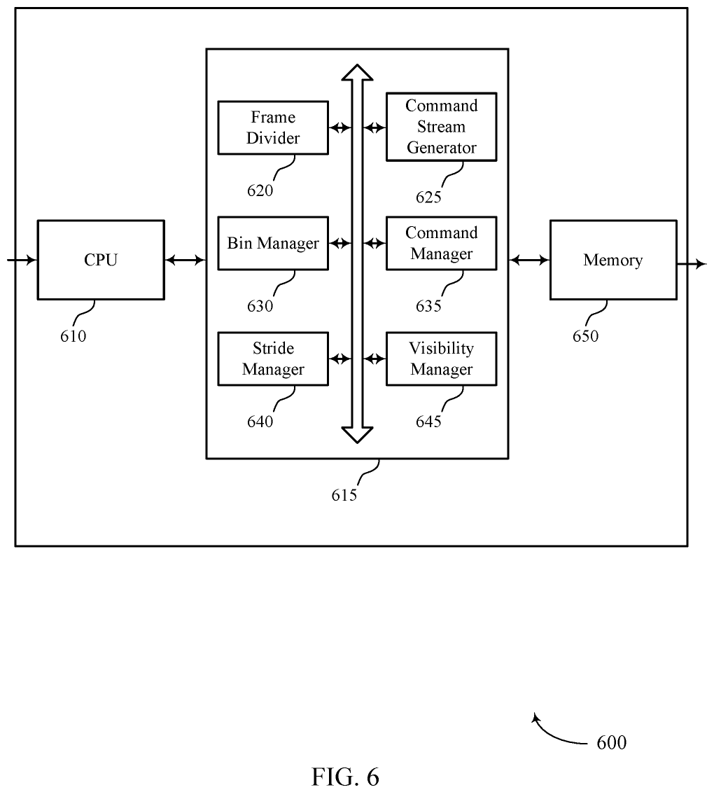

FIG. 6 shows a block diagram 600 of a device 605 that supports fixed-stride draw tables for tiled rendering in accordance with aspects of the present disclosure. The device 605 may be an example of aspects of a device as described herein. The device 605 may include a CPU 610, a rendering manager 615, and a display 650. The rendering manager 615 may include a frame divider 620, a command stream generator 625, a bin manager 630, a command manager 635, a stride manager 640, and a visibility manager 645. Each of these modules may communicate, directly or indirectly, with one another (e.g., via one or more buses).

CPU 610 may execute one or more software applications, such as web browsers, graphical user interfaces, video games, or other applications involving graphics rendering for image depiction (e.g., via display 650). As described above, CPU 610 may encounter a GPU program (e.g., a program suited for handling by a GPU) when executing the one or more software applications. Accordingly, CPU 610 may submit rendering commands (e.g., a command stream) to a command processor of a GPU (e.g., via a GPU driver containing a compiler for parsing API-based commands).

The rendering manager 615, or its sub-components, may be implemented in hardware, code (e.g., software or firmware) executed by a processor, or any combination thereof. If implemented in code executed by a processor, the functions of the rendering manager 615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The rendering manager 615, or its sub-components, may be physically located at various positions, including being distributed such that portions of functions are implemented at different physical locations by one or more physical components. In some examples, the rendering manager 615, or its sub-components, may be a separate and distinct component in accordance with various aspects of the present disclosure. In some examples, the rendering manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The frame divider 620 may divide a frame into a set of bins. The command stream generator 625 may generate a command stream including a set of repetitions of a FSDT, where each repetition of the FSDT includes a respective state vector for one or more hardware registers of a set of hardware registers. In some examples, the command stream generator 625 may generate a set of one or more repetition indices for each bin, where each repetition index indicates a respective repetition of the FSDT that includes a live draw call for that bin. In some examples, the command stream generator 625 may pass the command stream from a central processor of the device to a command processor of a GPU. In some cases, each repetition of the FSDT includes a respective state vector for each hardware register of the set of hardware registers.

The bin manager 630 may identify, for each bin, a subset of the set of repetitions of the FSDT in the command stream that include a live draw call. The command manager 635 may execute, using the set of hardware registers, one or more rendering commands for each bin based on the corresponding subset of the set of repetitions of the FSDT. In some examples, the command manager 635 may localize a DMA engine of a GPU to the subset of the set of repetitions of the FSDT that include a live draw call for that bin within the command stream based on the corresponding set of one or more repetition indices.

The stride manager 640 may compute a stride length between successive repetitions of the FSDT that include a live draw call for that bin based on a size of the FSDT and the repetition indices for the successive repetitions of the FSDT, where the DMA engine is localized based on the stride length. The visibility manager 645 may perform a visibility pass operation on the set of bins, where the subset of the set of repetitions of the FSDT in the command stream that include a live draw call for each bin is identified based on the visibility pass operation.

Display 650 may display content generated by other components of the device. In some examples, display 650 may be connected with a display buffer which stores rendered data until an image is ready to be displayed. Display 650 represents a unit capable of displaying video, images, text or any other type of data for consumption by a viewer. Display 650 may include a liquid-crystal display (LCD), a light emitting diode (LED) display, an organic LED (OLED), an active-matrix OLED (AMOLED), or the like.

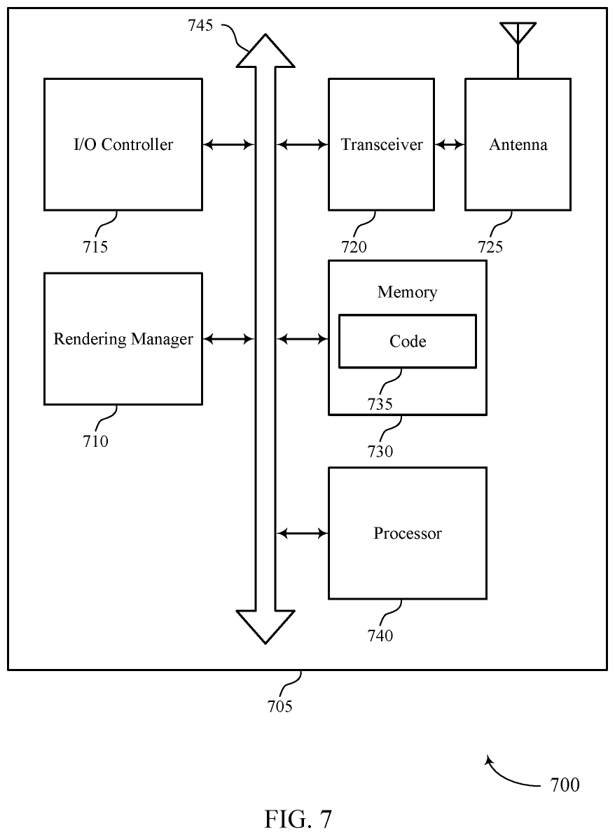

FIG. 7 shows a diagram of a system 700 including a device 705 that supports fixed-stride draw tables for tiled rendering in accordance with aspects of the present disclosure. The device 705 may include components for bi-directional voice and data communications including components for transmitting and receiving communications, including a rendering manager 710, an I/O controller 715, a transceiver 720, an antenna 725, memory 730, and a processor 740. These components may be in electronic communication via one or more buses (e.g., bus 745).

The rendering manager 710 may divide a frame into a set of bins. The rendering manager 710 may generate a command stream including a set of repetitions of a FSDT, where each repetition of the FSDT includes a respective state vector for one or more hardware registers of a set of hardware registers. The rendering manager 710 may identify, for each bin, a subset of the set of repetitions of the FSDT in the command stream that include a live draw call. The rendering manager 710 may execute, using the set of hardware registers, one or more rendering commands for each bin based on the corresponding subset of the set of repetitions of the FSDT.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described above. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas. In some cases, the wireless device may include a single antenna 725. However, in some cases the device may have more than one antenna 725, which may be capable of concurrently transmitting or receiving multiple wireless transmissions.

The memory 730 may include RAM and ROM. The memory 730 may store computer-readable, computer-executable code 735 including instructions that, when executed, cause the processor to perform various functions described herein. In some cases, the memory 730 may contain, among other things, a BIOS which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting fixed-stride draw tables for tiled rendering).

The code 735 may include instructions to implement aspects of the present disclosure, including instructions to support rendering. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

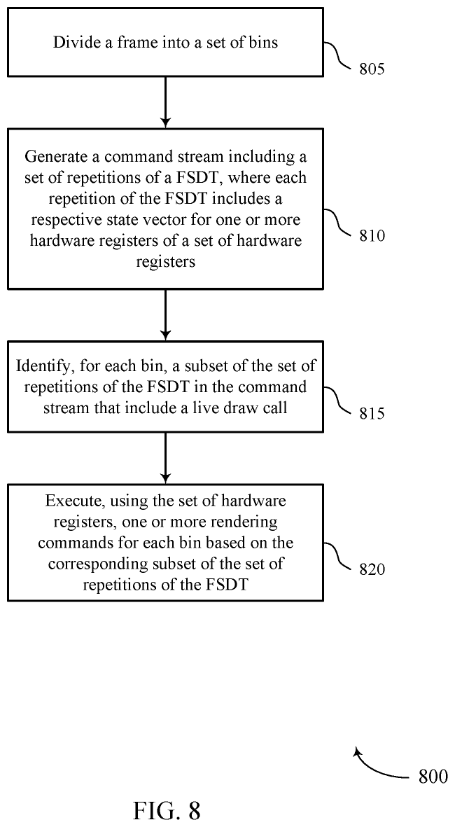

FIG. 8 shows a flowchart illustrating a method 800 that supports fixed-stride draw tables for tiled rendering in accordance with aspects of the present disclosure. The operations of method 800 may be implemented by a device or its components as described herein. For example, the operations of method 800 may be performed by a rendering manager as described with reference to FIGS. 6 and 7. In some examples, a device may execute a set of instructions to control the functional elements of the device to perform the functions described below. Additionally, or alternatively, a device may perform aspects of the functions described below using special-purpose hardware.

At 805, the device may divide a frame into a set of bins. The operations of 805 may be performed according to the methods described herein. In some examples, aspects of the operations of 805 may be performed by a frame divider as described with reference to FIG. 6.

At 810, the device may generate a command stream including a set of repetitions of a FSDT, where each repetition of the FSDT includes a respective state vector for one or more hardware registers of a set of hardware registers. The operations of 810 may be performed according to the methods described herein. In some examples, aspects of the operations of 810 may be performed by a command stream generator as described with reference to FIG. 6.

At 815, the device may identify, for each bin, a subset of the set of repetitions of the FSDT in the command stream that include a live draw call. The operations of 815 may be performed according to the methods described herein. In some examples, aspects of the operations of 815 may be performed by a bin manager as described with reference to FIG. 6.

At 820, the device may execute, using the set of hardware registers, one or more rendering commands for each bin based on the corresponding subset of the set of repetitions of the FSDT. The operations of 820 may be performed according to the methods described herein. In some examples, aspects of the operations of 820 may be performed by a command manager as described with reference to FIG. 6.

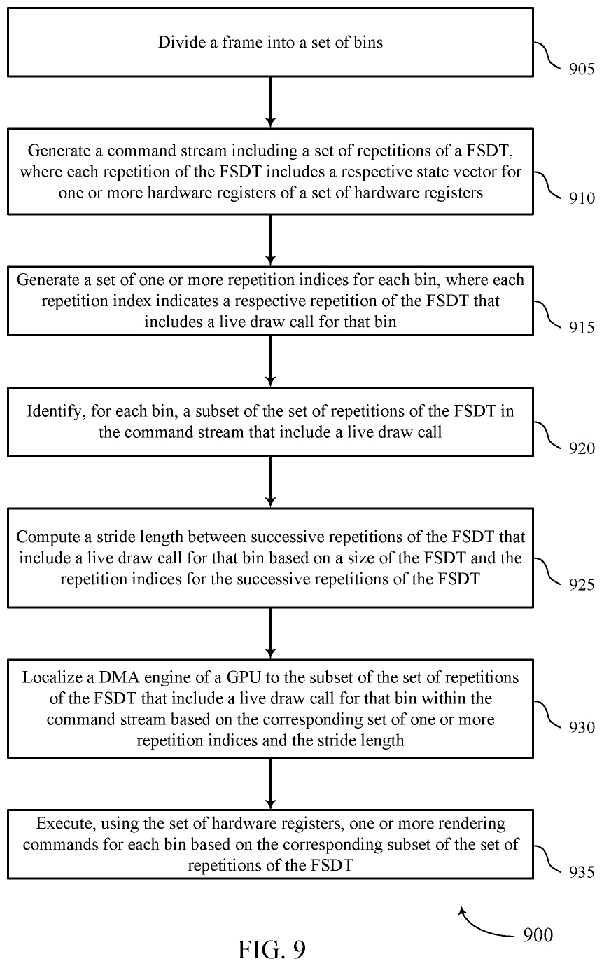

FIG. 9 shows a flowchart illustrating a method 900 that supports fixed-stride draw tables for tiled rendering in accordance with aspects of the present disclosure. The operations of method 900 may be implemented by a device or its components as described herein. For example, the operations of method 900 may be performed by a rendering manager as described with reference to FIGS. 6 and 7. In some examples, a device may execute a set of instructions to control the functional elements of the device to perform the functions described below. Additionally, or alternatively, a device may perform aspects of the functions described below using special-purpose hardware.

At 905, the device may divide a frame into a set of bins. The operations of 905 may be performed according to the methods described herein. In some examples, aspects of the operations of 905 may be performed by a frame divider as described with reference to FIG. 6.

At 910, the device may generate a command stream including a set of repetitions of a FSDT, where each repetition of the FSDT includes a respective state vector for one or more hardware registers of a set of hardware registers. The operations of 910 may be performed according to the methods described herein. In some examples, aspects of the operations of 910 may be performed by a command stream generator as described with reference to FIG. 6.

At 915, the device may generate a set of one or more repetition indices for each bin, where each repetition index indicates a respective repetition of the FSDT that includes a live draw call for that bin. The operations of 915 may be performed according to the methods described herein. In some examples, aspects of the operations of 915 may be performed by a command stream generator as described with reference to FIG. 6.

At 920, the device may identify, for each bin, a subset of the set of repetitions of the FSDT in the command stream that include a live draw call. The operations of 920 may be performed according to the methods described herein. In some examples, aspects of the operations of 920 may be performed by a bin manager as described with reference to FIG. 6.

At 925, the device may compute a stride length between successive repetitions of the FSDT that include a live draw call for that bin based on a size of the FSDT and the repetition indices for the successive repetitions of the FSDT, where the DMA engine is localized based on the stride length. The operations of 925 may be performed according to the methods described herein. In some examples, aspects of the operations of 925 may be performed by a stride manager as described with reference to FIG. 6.

At 930, the device may localize a DMA engine of a GPU to the subset of the set of repetitions of the FSDT that include a live draw call for that bin within the command stream based on the corresponding set of one or more repetition indices. The operations of 930 may be performed according to the methods described herein. In some examples, aspects of the operations of 930 may be performed by a command manager as described with reference to FIG. 6.

At 935, the device may execute, using the set of hardware registers, one or more rendering commands for each bin based on the corresponding subset of the set of repetitions of the FSDT. The operations of 935 may be performed according to the methods described herein. In some examples, aspects of the operations of 935 may be performed by a command manager as described with reference to FIG. 6.

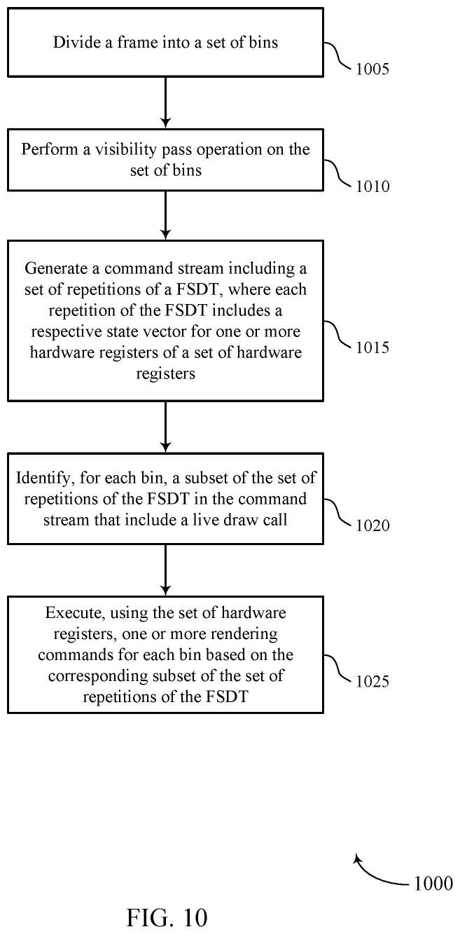

FIG. 10 shows a flowchart illustrating a method 1000 that supports fixed-stride draw tables for tiled rendering in accordance with aspects of the present disclosure. The operations of method 1000 may be implemented by a device or its components as described herein. For example, the operations of method 1000 may be performed by a rendering manager as described with reference to FIGS. 6 and 7. In some examples, a device may execute a set of instructions to control the functional elements of the device to perform the functions described below. Additionally, or alternatively, a device may perform aspects of the functions described below using special-purpose hardware.

At 1005, the device may divide a frame into a set of bins. The operations of 1005 may be performed according to the methods described herein. In some examples, aspects of the operations of 1005 may be performed by a frame divider as described with reference to FIG. 6.

At 1010, the device may perform a visibility pass operation on the set of bins. The operations of 1010 may be performed according to the methods described herein. In some examples, aspects of the operations of 1010 may be performed by a visibility manager as described with reference to FIG. 6.

At 1015, the device may generate a command stream including a set of repetitions of a FSDT, where each repetition of the FSDT includes a respective state vector for one or more hardware registers of a set of hardware registers. The operations of 1015 may be performed according to the methods described herein. In some examples, aspects of the operations of 1015 may be performed by a command stream generator as described with reference to FIG. 6.

At 1020, the device may identify, for each bin, a subset of the set of repetitions of the FSDT in the command stream that include a live draw call. The operations of 1020 may be performed according to the methods described herein. In some examples, aspects of the operations of 1020 may be performed by a bin manager as described with reference to FIG. 6.

At 1025, the device may execute, using the set of hardware registers, one or more rendering commands for each bin based on the corresponding subset of the set of repetitions of the FSDT. The operations of 1025 may be performed according to the methods described herein. In some examples, aspects of the operations of 1025 may be performed by a command manager as described with reference to FIG. 6.

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random- access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for rendering at a device, comprising:
dividing a frame into a plurality of bins;
generating a command stream comprising a plurality of repetitions of a fixed- stride draw table (FSDT), wherein each repetition of the FSDT comprises a respective state vector for one or more hardware registers of a set of hardware registers;
identifying, for each bin, a subset of the plurality of repetitions of the FSDT in the command stream that include a live draw call; and
executing, using the set of hardware registers, one or more rendering commands for each bin based at least in part on the corresponding subset of the plurality of repetitions of the FSDT.

2. The method of claim 1, wherein generating the command stream comprises:
generating a set of one or more repetition indices for each bin, wherein each repetition index indicates a respective repetition of the FSDT that includes a live draw call for that bin.

3. The method of claim 2, wherein executing the one or more rendering commands for each bin comprises:
localizing a direct memory access (DMA) engine of a graphics processing unit (GPU) to the subset of the plurality of repetitions of the FSDT that include a live draw call for that bin within the command stream based at least in part on the corresponding set of one or more repetition indices.

4. The method of claim 3, further comprising:
computing a stride length between successive repetitions of the FSDT that include a live draw call for that bin based at least in part on a size of the FSDT and the repetition indices for the successive repetitions of the FSDT, wherein the DMA engine is localized based at least in part on the stride length.

5. The method of claim 1, wherein each repetition of the FSDT comprises a respective state vector for each hardware register of the set of hardware registers.

6. The method of claim 1, wherein each repetition of the FSDT comprises a respective state vector for each hardware register of the set of hardware registers.

7. The method of claim 1, further comprising:
performing a visibility pass operation on the plurality of bins, wherein the subset of the plurality of repetitions of the FSDT in the command stream that include a live draw call for each bin is identified based at least in part on the visibility pass operation.

8. The method of claim 1, further comprising:
passing the command stream from a central processor of the device to a command processor of a graphics processing unit (GPU).

9. An apparatus for rendering, comprising:
a processor,
memory in electronic communication with the processor; and
instructions stored in the memory and executable by the processor to cause the apparatus to:
divide a frame into a plurality of bins;
generate a command stream comprising a plurality of repetitions of a fixed-stride draw table (FSDT), wherein each repetition of the FSDT comprises a respective state vector for one or more hardware registers of a set of hardware registers;
identify, for each bin, a subset of the plurality of repetitions of the FSDT in the command stream that include a live draw call; and
execute, using the set of hardware registers, one or more rendering commands for each bin based at least in part on the corresponding subset of the plurality of repetitions of the FSDT.

10. The apparatus of claim 9, wherein the instructions to generate the command stream are executable by the processor to cause the apparatus to:
generate a set of one or more repetition indices for each bin, wherein each repetition index indicates a respective repetition of the FSDT that includes a live draw call for that bin.

11. The apparatus of claim 10, wherein the instructions to execute the one or more rendering commands for each bin are executable by the processor to cause the apparatus to:
localize a direct memory access (DMA) engine of a graphics processing unit (GPU) to the subset of the plurality of repetitions of the FSDT that include a live draw call for that bin within the command stream based at least in part on the corresponding set of one or more repetition indices.

12. The apparatus of claim 11, wherein the instructions are further executable by the processor to cause the apparatus to:
compute a stride length between successive repetitions of the FSDT that include a live draw call for that bin based at least in part on a size of the FSDT and the repetition indices for the successive repetitions of the FSDT, wherein the DMA engine is localized based at least in part on the stride length.

13. The apparatus of claim 9, wherein the instructions are further executable by the processor to cause the apparatus to:
perform a visibility pass operation on the plurality of bins, wherein the subset of the plurality of repetitions of the FSDT in the command stream that include a live draw call for each bin is identified based at least in part on the visibility pass operation.

14. The apparatus of claim 9, wherein the instructions are further executable by the processor to cause the apparatus to:
pass the command stream from a central processor of the apparatus to a command processor of a graphics processing unit (GPU).

15. A non-transitory computer-readable medium storing code for rendering at a device, the code comprising instructions executable by a processor to:
divide a frame into a plurality of bins;
generate a command stream comprising a plurality of repetitions of a fixed- stride draw table (FSDT), wherein each repetition of the FSDT comprises a respective state vector for one or more hardware registers of a set of hardware registers;
identify, for each bin, a subset of the plurality of repetitions of the FSDT in the command stream that include a live draw call; and
execute, using the set of hardware registers, one or more rendering commands for each bin based at least in part on the corresponding subset of the plurality of repetitions of the FSDT.

16. The non-transitory computer-readable medium of claim 15, wherein the instructions to generate the command stream are executable to:
generate a set of one or more repetition indices for each bin, wherein each repetition index indicates a respective repetition of the FSDT that includes a live draw call for that bin.

17. The non-transitory computer-readable medium of claim 16, wherein the instructions to execute the one or more rendering commands for each bin are executable to:
localize a direct memory access (DMA) engine of a graphics processing unit (GPU) to the subset of the plurality of repetitions of the FSDT that include a live draw call for that bin within the command stream based at least in part on the corresponding set of one or more repetition indices.

18. The non-transitory computer-readable medium of claim 17, wherein the instructions are further executable to:
compute a stride length between successive repetitions of the FSDT that include a live draw call for that bin based at least in part on a size of the FSDT and the repetition indices for the successive repetitions of the FSDT, wherein the DMA engine is localized based at least in part on the stride length.

19. The non-transitory computer-readable medium of claim 15, wherein the instructions are further executable to:
perform a visibility pass operation on the plurality of bins, wherein the subset of the plurality of repetitions of the FSDT in the command stream that include a live draw call for each bin is identified based at least in part on the visibility pass operation.

20. The non-transitory computer-readable medium of claim 15, wherein the instructions are further executable to:
pass the command stream from a central processor of the device to a command processor of a graphics processing unit (GPU).
